(19) United States
(12) Patent Application Publication
(10) Pub. No.: US 2024/0063499 A1
(43) Pub. Date: Feb. 22, 2024

(54) BATTERY CONTAINER VENTS WITH PRESSURE BURST COVERS USING ELECTRICAL INTERLOCKS FOR DETECTING THERMAL EVENTS

(71) Applicant: GM GLOBAL TECHNOLOGY OPERATIONS LLC, Detroit, MI (US)

(72) Inventor: Benjamin G. Wroblewski, Ferndale, MI (US)

(73) Assignee: GM GLOBAL TECHNOLOGY OPERATIONS LLC, Detroit, MI (US)

(21) Appl. No.: 17/888,577

(22) Filed: Aug. 16, 2022

(51) Int. Cl. H01M 50/342; H01M 50/375; H01M 10/48

(52) U.S. Cl. CPC H01M 50/3425; H01M 50/375; H01M 10/48; H01M 2220/20; H01M 10/052

(57) ABSTRACT

Presented are pressure burst covers with electrical interlocks for battery vents, methods for making/using such covers, and motor vehicles equipped with such covers for detecting thermal events in lithium-class batteries. A battery assembly includes an electrochemical battery cell housed inside a battery container. The battery container includes a fluid port that evacuates therethrough cell-generated gases. A pressure burst cap is movably attached to the battery container to selectively transition from a closed position, whereat the cap covers the port, to an open position, whereat the cap partially or fully uncovers the port. An electrical interlock circuit, which is connected to a controller, includes a circuit lead that is attached to the pressure burst cap and battery container. The circuit lead holds the cap in the closed position and fails at a preset rupture force to create an open circuit signal within the electrical interlock circuit indicative of a thermal event.

### INTRODUCTION

The present disclosure relates generally to electrochemical devices. More specifically, aspects of this disclosure relate to thermal management systems for detecting thermal runaway (TR) events in battery assemblies.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, rechargeable battery cells, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

High-voltage (HV) electrical systems govern the transfer of electricity between the traction motors and the rechargeable battery packs that supply the requisite power for operating many hybrid-electric and full-electric powertrains. To provide the power capacity and energy density needed to propel a vehicle at desired speeds and ranges, contemporary traction battery packs group multiple battery cells (e.g., 8-16+ cells/stack) into individual battery modules (e.g., 10-40+ modules/pack) that are electrically interconnected in series or parallel and mounted onto the vehicle chassis, e.g., by a battery pack housing or support tray. Located on a battery side of the HV electric system is a front-end DC-to-DC power converter that is electrically connected to the traction battery pack(s) in order to increase the supply of voltage to a main DC bus and a DC-to-AC power inverter module (PIM). A high-frequency bulk capacitor may be arranged across the positive and negative terminals of the main DC bus to provide electrical stability and store supplemental electrical energy. A dedicated Electronic Battery Control Module (EBCM), through collaborative operation with a Powertrain Control Module (PCM) and each motor's power electronics package, governs operation of the battery pack(s) and traction motor(s).

The individual cells of a battery pack may generate a significant amount of heat during the pack's charge and discharge cycles. This cell-borne heat is produced primarily by exothermic chemical reactions and losses due to activation energy, chemical transport, and resistance to ionic migration. Within lithium-ion batteries, a series of exothermic and gas-generating reactions may take place as cell temperatures rise and may push the battery assembly towards an unstable state. Such thermal events, if left unchecked, may lead to a more accelerated heat-generating state called “thermal runaway”, a condition in which the battery system is incapable of returning the internal battery components to normal operating temperatures. An integrated battery cooling system may be employed to prevent these undesirable overheating conditions within such battery packs. Active thermal management (ATM) systems, for example, employ a central controller or dedicated control module to regulate operation of a cooling circuit that circulates coolant fluid through the heat-producing battery components. For indirect liquid cooling systems, a heat-transfer coolant is circulated through a network of internal channels and pipes within the battery case. In contrast, direct liquid cooling systems—or “liquid immersion cooling” (LIC) systems—immerse the battery cells within a direct-conduction liquid dielectric coolant.

### SUMMARY

Presented herein are pressure burst covers with electrified interlocks for gas vents of battery containers, methods for manufacturing and methods for using such pressure burst covers, and electric-drive vehicles equipped with such interlock-bearing pressure burst covers for detecting thermal events in lithium-class traction battery packs. For example, there are disclosed battery module housings or battery cell cases (collectively “battery container”) with fluid vents for passively evacuating therethrough battery-generated gases. These gas vents are covered by pressure burst discs, panels, or other similarly suitable valve designs (collectively referred to as “cap” or “cover”) that extend across and, if desired, fluidly seal the vents. Each pressure burst cover may have a single-piece, disc-shaped construction and may be secured in place by one or more electrical leads of a low-voltage (LV) interlock circuit. The electrical lead(s) may extend through or across an outer surface of the vent cover and may electrically connect to a voltage sensing device integral with or connected to a system controller. In an example, the electrical lead consists essentially of an electrically conductive wire that is fixedly attached to both the vent cover and battery container, movably mounting the cover to the container. Likewise, the pressure burst cover may consist essentially of an electrically non-conductive disc or panel.

This design provisions thermal runaway detection by using the integrated LV interlock circuit lead(s) to monitor the displacement of the pressure burst relief valve. If a battery cell or module descends into thermal runaway, it may generate a large amount of heat and gas that, in turn, create a build-up of pressure inside the battery container. When the resultant internal pressure meets or exceeds a predefined threshold burst pressure, the interlock circuit lead(s) will partially fail or rupture. In so doing, the pressure burst cover may physically detach from the container to release the internal heat and gas pressure from the battery system. Disconnecting the interlock circuit lead(s) in this manner will also create an open circuit in the TR detection system. A microcontroller may monitor the interlock circuit and may use the opening of the circuit to flag the onset of a thermal runaway event. Fast and accurate detection of a TR event enables the system to more quickly automate mitigating measures to abate the effects of the thermal event.

Existing thermal runaway detection techniques oftentimes rely on pack-level architectures for sensor placement and controls strategy. Contrastingly, disclosed concepts employ cell-level and/or module-level detection and control without having to place dedicated sensors and communication devices on each cell/module. Eliminating the placement of sensors and connectors on each cell/module in a battery system with dozens/hundreds of modules/cells helps to reduce system part counts and costs, decreases manufacturing time and costs, and simplifies overall system design. Other attendant benefits may include reducing battery system weight and packaging volume with concomitant savings in gross vehicle size and weight. In addition to reducing system complexity and vehicle weight, thermal management is improved with a concomitant increase in battery capacity, which leads to improvements in overall vehicle efficiency and increased driving range.

Aspects of this disclosure are directed to pressure burst covers with electrified interlocks for gas vents of battery assemblies, including individual battery cell assemblies or individual battery module assemblies. In a non-limiting example, a battery assembly includes a battery container that houses therein one or more electrochemical battery cells. The battery container includes at least one wall with a fluid port that evacuates therethrough cell-generated gases. A pressure burst cap is movably attached to the battery container to selectively transition between a closed position and an open position. When in the closed position, the pressure burst cap covers the fluid port. Conversely, when in the open position, the pressure burst cap partially of completely uncovers the port. The battery assembly also includes an electrical interlock circuit that is electrically connected to a resident or remote system controller. The electrical interlock circuit includes an electrical circuit lead (e.g., for a battery cell application) or a network of electrical leads (e.g., for a battery module/pack application), with each lead attached to a pressure burst cap and a battery container. The circuit lead holds the pressure burst cap in the closed position and, when subjected to a preset rupture force, fails to thereby open the gas port and create an open circuit signal within the electrical interlock circuit indicative of a thermal event.

Additional aspects of this disclosure are directed to motor vehicles with lithium-class traction battery packs that employ any of the herein described pressure burst covers for detecting the onset of a thermal event. As used herein, the terms “vehicle” and “motor vehicle” may be used interchangeably and synonymously to include any relevant vehicle platform, such as passenger vehicles (ICE, HEY, FEV, fuel cell, fully and partially autonomous, etc.), commercial vehicles, industrial vehicles, tracked vehicles, off-road and all-terrain vehicles (ATV), motorcycles, farm equipment, e-scooters, e-bikes, watercraft, aircraft, etc. For non-automotive applications, disclosed concepts may be implemented for any logically relevant use, including stand-alone power stations and portable power packs, photovoltaic systems, pumping equipment, machine tools, server systems, etc. While not per se limited, disclosed concepts may be particularly advantageous for use with lithium-class prismatic can-type traction battery packs.

In an example, a motor vehicle includes a vehicle body with a passenger compartment, multiple road wheels mounted to the vehicle body (e.g., via corner modules coupled to a unibody or body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to propel the vehicle. A rechargeable traction battery pack is attached to the vehicle body, e.g., via a pack housing or support tray mounted onto the vehicle chassis, and electrically connected to the traction motor, i.e., to transmit electrical energy thereto.

Continuing with the preceding discussion, the traction battery pack includes an electrical interlock circuit that is electrically connected to a resident or remote controller and includes a network of circuit leads. The traction battery pack also contains a cluster of lithium-class battery cells, such as prismatic, can, or pouch-type battery cells. Each battery cell includes a battery stack with one or more pairs of working electrodes, one or more separators, one or more insulators, and an ion-transmitting electrolyte. Each battery stack is housed inside a respective cell case, which includes a wall with a fluid port that evacuates therethrough cell gases generated by the battery stack. A pressure burst cap is movably attached to each cell case to transition from a closed position, whereat the pressure burst cap covers that cell case's fluid port, to an open position, whereat the pressure burst cap uncovers the fluid port. A circuit lead within the network of circuit leads movably mounts each pressure burst cap to its cell case. The circuit lead holds the pressure burst cap in the closed position; when subjected to a minimum tensile/torsional rupture force caused by elevated pressures within the cell case, the lead partially or wholly fails. In so doing, the circuit lead at least partially detaches the pressure burst cap from the cell case such that the cap transitions to the open position. At the same time, the failed lead creates an open circuit signal within the electrical interlock circuit that is indicative of a thermal runaway event.

Aspects of this disclosure are also directed to manufacturing workflow processes for making, computer readable media (CRM) for operating, and control logic for using any of the disclosed pressure burst covers, battery assemblies, and/or vehicles. In an example, a method is presented for constructing a battery assembly. This representative method includes, in any order and in any combination with any of the above and below disclosed options and features: fabricating, assembling, accepting, or retrieving (collectively “receiving”) an electrochemical battery cell; receiving a battery container; placing the battery cell inside the battery container, the battery container including a container wall with a fluid port configured to evacuate therethrough cell-generated gas; placing a pressure burst cap over the fluid port such that the pressure burst cap is able to selectively transition from a closed position, whereat the pressure burst cap covers the fluid port, to an open position, whereat the pressure burst cap at least partially uncovers the fluid port; receiving an electrical interlock circuit configured to connect to a controller and including a circuit lead; and attaching the circuit lead to the pressure burst cap and the battery container, the circuit lead holding the pressure burst cap in the closed position and configured to fail at a preset rupture force thereby creating an open circuit signal within the electrical interlock circuit indicative of a thermal event.

For any of the disclosed batteries, methods, and vehicles, the circuit lead movably mounts the pressure burst cap to the battery container such that the pressure burst cap selectively moves from the closed position to the open position upon failure of the circuit lead. Optional embodiments may employ a separate mechanism for pivotably, slidably, or removably mounting the pressure burst cap to the battery container such that the circuit lead functions primarily to hold the cap closed and to trigger an open circuit in response to the onset of a TR event. In another option, the circuit lead may deform, fracture, or completely break (collectively “fail”) at the preset rupture force such that the pressure burst cap physically detaches, in whole or in part, from the battery container. A left or top (first) side of the pressure burst cap may be mounted by one (first) segment of the circuit lead to a distinct (first) section of the battery container, while a right or bottom (second) side of the pressure burst cap is mounted by another (second) segment of the circuit lead to a respective (second) section of the battery container.

For any of the disclosed batteries, methods, and vehicles, the circuit lead may include or, if desired, may consist essentially of an electrical wire that is formed, in whole or in part, from an electrically conductive material. Moreover, the circuit lead may be fixedly mounted to both the pressure burst cap and the battery container; if desired, the lead may extend across exterior surfaces of both of the pressure burst cap and the battery container. Alternatively, the circuit lead may be integrally formed with one or both of the cap and container such that the lead extends through the cap/container. As yet another option, the circuit lead may include an electrical connector (e.g., pin-and-sleeve connector, pin-and-socket connector, single-pole connector, crimp connector, terminal block connector, etc.) that holds the pressure burst cap in the closed position and opens at the preset rupture force.

For any of the disclosed batteries, methods, and vehicles, the pressure burst cap, when in the closed position, may extend the entire way across and conceal the fluid port. As another option, the pressure burst cap may sit substantially flush against the container wall, circumscribing the fluid port. When in the closed position, the pressure burst cap may fluidly seal the fluid port (e.g., using a polymeric gasket or ring seal). Conversely, when moved to the open position, the cap fluidly unseals the fluid port. The pressure burst cap may be fabricated as a single-piece structure that is formed, in whole or in part, from a high-temperature, flame-resistant and slow-burning polymeric material.

For any of the disclosed batteries, methods, and vehicles, the circuit lead may maintain an electrical voltage across at least one branch of the electrical interlock circuit that is detectable by the system controller. In this instance, the open circuit signal is created by discontinuation of the electrical voltage across the electrical interlock circuit when the circuit lead fails at the preset rupture force. As noted above, the battery assembly may be a battery module or a battery cell. For a battery module application, the battery container may include a battery module housing and the electrochemical battery cell may include a cluster of lithium-class battery cells. For a battery cell application, the battery container may include a battery cell case, and the electrochemical battery cell may include multiple working electrodes, a separator, an insulator, and an electrolyte, all of which are contained inside the battery cell case.

The above Summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with an electrified powertrain, a rechargeable traction battery pack, and a pack monitoring system for detecting a thermal event in the traction battery pack according to aspects of the disclosed concepts.

FIG. 2 is an enlarged, perspective-view illustration of a representative battery assembly in the form of a battery module with a battery housing vent covered by a pressure burst cap using an electrified interlock lead for detecting thermal events in accord with aspects of this disclosure.

FIGS. 3A and 3B are schematic top-view illustrations of another representative battery assembly in the form of a lithium-class prismatic battery cell with a pressure burst cap closed with an electrified interlock lead connected (FIG. 3A) and the pressure burst disc opened with the interlock lead electrically disconnected (FIG. 3B) in accord with aspects of the disclosed concepts.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

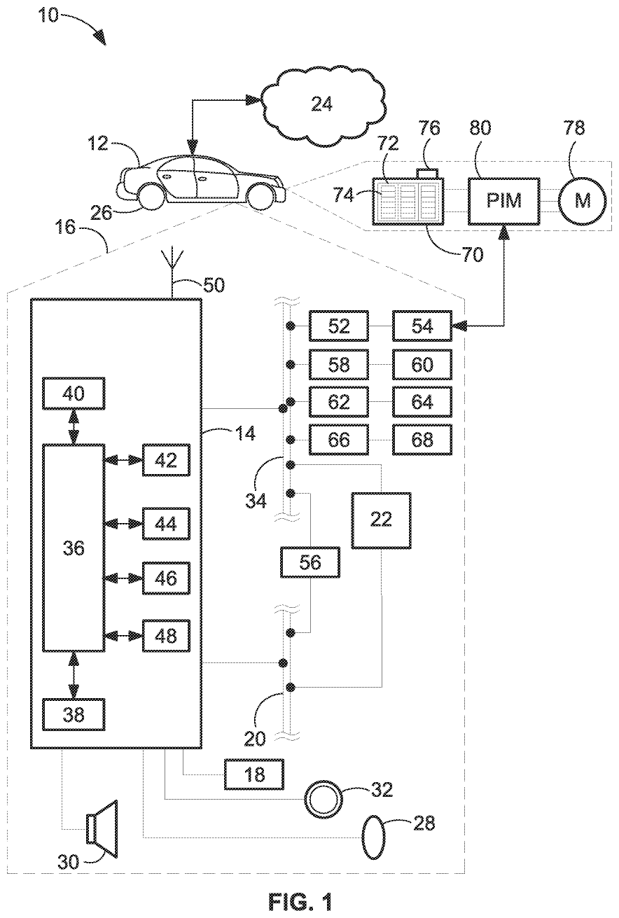

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which novel aspects of this disclosure may be practiced. In the same vein, incorporation of the present concepts into an FEV powertrain should be appreciated as a non-limiting implementation of disclosed features. As such, it will be understood that aspects and features of this disclosure may be applied to other powertrain architectures, incorporated into any logically relevant type of vehicle, and utilized for both automotive and non-automotive applications alike. Moreover, only select components of the motor vehicles, battery assemblies, and pressure burst caps are shown and described in additional detail herein. Nevertheless, the vehicles, assemblies, and caps discussed below may include numerous additional and alternative features, and other available peripheral components, for carrying out the various methods and functions of this disclosure.

The representative vehicle 10 of FIG. 1 is originally equipped with a vehicle telecommunications and information (“telematics”) unit 14 that wirelessly communicates, e.g., via cell towers, base stations, mobile switching centers, satellite service, etc., with a remotely located or “off-board” cloud computing host service 24 (e.g., ONSTAR®). Some of the other vehicle hardware components 16 shown generally in FIG. 1 include, as non-limiting examples, an electronic video display device 18, a microphone 28, audio speakers 30, and assorted user input controls 32 (e.g., buttons, knobs, touchscreens, joysticks, pedals, etc.). These hardware components 16 may function as a human/machine interface (HMI) that enables a user to communicate with the telematics unit 14 and other components resident to and remote from the vehicle 10. A microphone 28, for instance, provides occupants with a means to input verbal or other auditory commands. Conversely, a speaker 30 provides audible output to a vehicle occupant and may be either a stand-alone speaker dedicated for use with the telematics unit 14 or may be part of an audio system 22. The audio system 22 is connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating a brake system, regulating charge and discharge of a vehicle battery pack, and other automated functions. For instance, telematics unit 14 may exchange signals with a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc.

Long-range communication (LRC) capabilities with remote, off-board devices may be provided via one or more or all of a cellular chipset/component, a wireless modem, or a navigation and location chipset/component (e.g., global positioning system (GPS) transceiver), all of which are collectively represented at 44. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual antenna 50. The communications devices described above may provision data exchanges as part of a periodic broadcast in a vehicle-to-vehicle (V2V) communication system or a vehicle-to-everything (V2X) communication system, e.g., Vehicle-to-Infrastructure (V2I), etc.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automation and concomitant autonomous vehicle operation.

To propel the motor vehicle 10, an electrified powertrain is operable to generate and deliver tractive torque to one or more of the vehicle's drive wheels 26. The powertrain is generally represented in FIG. 1 by an electric traction motor (M) 78 that is operatively connected to a rechargeable energy storage system (RESS), which may be in the nature of a chassis-mounted traction battery pack 70. The traction battery pack 70 of FIG. 1 employs one or more battery modules 72, each of which contains a group of battery cells 74, such as stacked lithium-class, zinc-class, nickel-class, or organosilicon-class battery cells of the prismatic, pouch, or cylindrical type. One or more prime movers, such as traction motor (M) 78, draw electrical power from and, optionally, deliver electrical power to the battery pack 70. A power inverter module (PIM) 80 electrically connects the battery pack 70 to the motor(s) 78 and modulates the transfer of electrical current therebetween. Disclosed concepts are similarly applicable to HEV and ICE-based powertrains. Module management, cell sensing, and module-to-module or module-to-host communication functionality may be integrated directly into each battery module 72 and performed by an integrated electronics package, such as a wireless-enabled cell monitoring unit (CMU) 76.

Under anomalous operating conditions, the battery pack 70 may become damaged or may malfunction in a manner that causes one or more of the cells 74 inside the battery modules 72 to generate excessive heat, sometime in excess of 400 to 500 degrees Celsius (° C.). If left unchecked, the cell(s) may descend into an uncontrollable, self-heating cycle known as “thermal runaway,” which may result in the ejection of high-temperature, high-pressure gases. Presented herein are pressure burst covers with electrified interlocks for gas vents of battery containers that facilitate the early detection of battery operating characteristics that are indicators of an oncoming TR event. Disclosed battery monitoring systems eliminate the need for individual pressure sensors that detect thermal runaway by monitoring an absolute or relative pressure at each cell. Rather, disclosed battery monitoring systems implement simplified, low-cost designs that combine a low-voltage interlock circuit with vent-covering pressure burst discs for thermal propagation detection. The pressure burst disc is a type of pressure-relief valve that opens to allow airflow through a fluid vent when a pressure differential is created across the disc's two opposing major faces. An electrical interlock circuit lead is mounted on or passes through the pressure burst disc; when the burst disc is forced opened by spiking internal TR gas pressures, the lead is designed to fail such that a system controller detects the oncoming TR event.

Integrating a low-voltage interlock circuit with vent-covering burst caps on the battery system cells/modules facilities the fast and easy detection of a cell/module in thermal runaway while reducing system part counts and costs, decreasing manufacturing time and costs, and simplifying overall system design. The pressure burst disc is designed to physically open to relieve pressure inside the corresponding battery container; when the pressure burst disc is pushed open to relieve internal gas pressure, it physically opens the electrical interlock circuit by deforming, fracturing, or breaking the lead. A system microcontroller or voltage sensor monitors the voltage across individual branches of the interlock circuit during operation of the battery system. When one of the leads is physically opened due to the pressure burst disc opening, the microcontroller or voltage sensor will detect a loss of voltage signal across that lead. The microcontroller/sensor uses the voltage loss as a state indicator that the pressure burst disc was forced open as a direct result of a thermal runaway event.

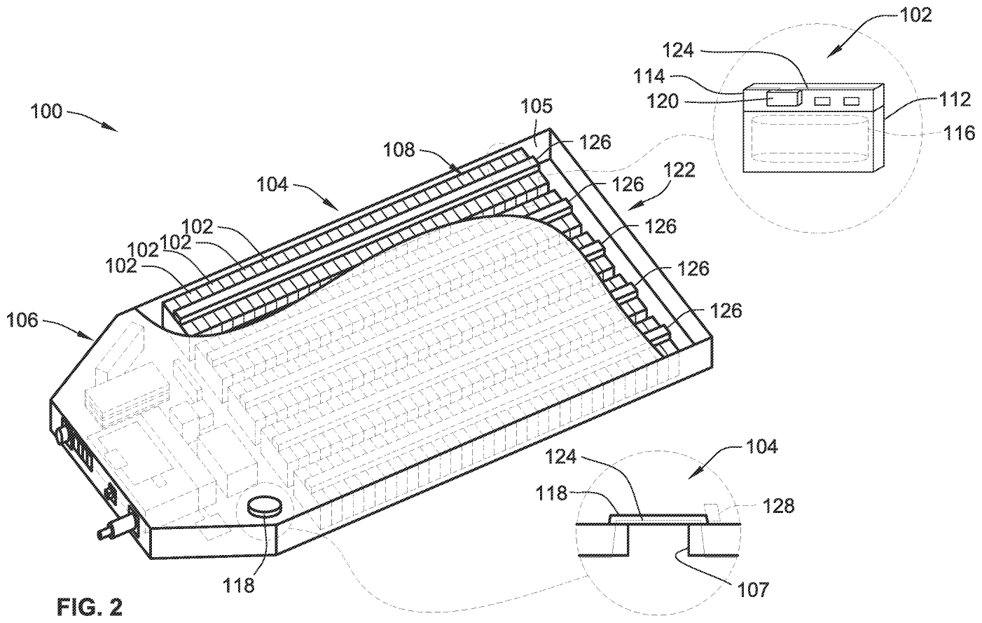

FIG. 2 presents a more detailed depiction of a representative battery assembly 100, which is portrayed as a prismatic lithium-class traction battery module for powering the electrified powertrain and electronic components of a motor vehicle, such as vehicle hardware components 16 and traction motor 78 of automobile 10 in FIG. 1. It should be appreciated, however, that disclosed concepts may be implemented for battery systems in both vehicular and non-vehicular applications alike. Moreover, recitation of a “battery assembly” in the Description and Claims may be to reference a battery pack assembly, a battery module assembly, a battery cell assembly, or any other applicable electrochemical device with a container that utilizes a fluid vent for evacuating cell-generated gases and is susceptible to inordinately high operating temperatures.

In the non-limiting example of FIG. 2, a group of prismatic battery cells 102 is stacked side-by-side and arranged in a rectangular array (e.g., five rows of thirty (30) cells per row) that is enclosed within an electrically insulated and protective battery container 104 (also referred to herein as “module housing”). This module housing 104 may be partitioned into two distinct sections: a power electronics compartment 106 that contains an assortment of battery power electronics (e.g., traction PIM, CMU, sensor package, etc.); and a cell compartment 108 that contains the stacked battery cells 102, a senseline assembly (not shown), and an interconnect board (not shown). The housing 104 may be constructed of a metallic, polymeric, or fiber-reinforced polymer (FRP) material, including combinations thereof, to satisfy various mechanical, manufacturing, and thermal design specifications. The battery module housing 104 may have a relatively flat construction with an octahedral shape, as shown, or may be constructed in other regular and irregular geometric configurations for accommodating application-specific parameters. Likewise, the battery assembly 100 may contain rectilinear stacks of lithium-ion prismatic can cells that share a common housing, as shown, or may contain a cluster or staggered array of battery cells, may contain pouch-type cells, cylindrical-type cells, or other cell form factor, and/or may employ other suitable battery technologies, such as those described above with respect to the battery cells 74 of FIG. 1.

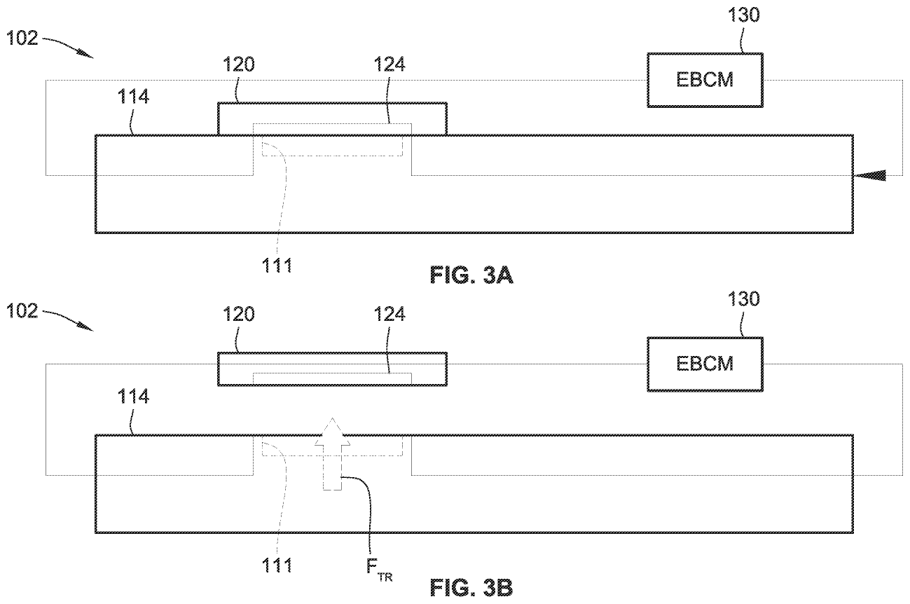

An inset view on the bottom of FIG. 2 is an enlarged, sectional side-view illustration showing a top wall 105 of the battery module housing 104 with a housing vent 107 for evacuating therethrough gases generated by any one of the cells 102 contained inside the cell compartment 108 of the housing 104. In the same vein, each of the battery cells 102 of FIG. 2 may be assembled with an electrically insulated and protective prismatic cell case 112 (top inset view) having a cell header 114 mounted onto a top end of the cell case 112. The cell header 114 is provided with a cell vent 111 (FIGS. 3A and 3B) through which is expelled gases generated via a battery jellyroll stack (shown hidden at 116) contained inside the case 112. A battery jellyroll stack 116 may contain one or more pairs of working (anode and cathode) electrodes, a separator sheet interposed between and separating each working electrode pair, an insulator sheet wrapped around the stack, and an electrically neutral (liquid, solid, or quasi-solid) electrolyte for transmitting ions back-and-forth between the anode(s) and cathode(s). Alternative system designs may employ only a single gas-evacuating port (e.g., housing vent 107) or only gas-evacuating cell ports (e.g., case vents 111), which may take on similar or distinct shapes, sizes, and locations from that shown in the drawings.

To protect the internal contents of a battery assembly during normal system operation, a pressure burst cover may overlay and conceal the gas-evacuating fluid port in the battery container. By way of non-limiting example, a disc-shaped pressure burst panel 120 is shown in FIG. 2 movably mounted onto the exterior face of the top wall 105 of the battery module housing 104, covering the housing vent 107. Likewise, a rectangular pressure burst panel 120 is shown movably mounted onto an exterior face of the cell header 114 of the cell case 112, covering the cell vent 111. The vent-covering plate 118 and panel 120, both of which are examples of a pressure burst cover or cap, may each be fabricated as a single-piece structure that is formed, in whole or in part, from a high-temperature, flame-resistant and slow-burning polymeric material (e.g., polybenzimidazole (PBI), polyether ether ketone (PEEK), polytetrafluoroethylene (PTFE), etc.). It should be appreciated that the illustrated pressure burst covers may take on an assortment of different shapes, sizes, and materials without departing from the intended scope of this disclosure.

To enable the evacuation of cell-generated gases from a battery container, a pressure burst cap uncovers its underlying fluid port to enable a measurable flow of fluid through the port under select operating conditions. As best seen in FIG. 3A, for example, the pressure burst panel 120 is securely mounted in a closed position, whereat the plate 118 covers and conceals the entire cell vent 111. When in the closed position, the pressure burst panel 120 sits substantially flush against an exterior surface of a sidewall of the cell header 114 and extends across the length and height of the cell vent 111. It may also be desirable that the pressure burst panel 120, when in the closed position, fluidly seals the vent 111 (e.g., using a polymeric gasket or ring seal). Once the internal pressure inside the cell case 112 meets or exceeds a predefined threshold burst pressure (e.g., 40 bar), the pressure burst panel 120 is forced outwardly to an open position, whereat the panel 120 partially or completely uncovers the cell vent 111, as best seen in FIG. 3B. It may also be desirable that the pressure burst panel 120 completely detaches from the cell case 112 and fluidly unseals the vent 111 when moved to the open position. The pressure burst plate 118 functions in much the same manner as the pressure burst panel 120 to securely cover and selectively uncover the housing vent 107.

An electrical interlock circuit 122 monitors the battery assembly to detect the onset of any one of multiple predefined thermal events. In accord with the illustrated example, the interlock circuit 122 of FIG. 2 is represented by a network of electrified circuit leads 124 that are interconnected via interlock bus interfaces 126 to a resident or remote processor, microcontroller, sensing device, or network of controllers/processors/devices (collectively represented by Electronic Battery Control Module (EBCM) 130 of FIGS. 3A and 3B). For the individual battery cells 102, each circuit lead 124 may be fabricated as an electrical wire that is fixedly mounted to and extends across adjoining exterior surfaces of the pressure burst panel 120 and the cell case header 114. For the battery module 100, the circuit lead 124 may be fabricated as an electrical wire that is routed through the interior of the module housing 104 and extends into and through the pressure burst plate 118 (e.g., for insulation and weatherproofing). It should be appreciated that the circuit leads 124 may take on any suitable electrical connector configuration and may be operatively attached to the battery container and pressure burst cover in any suitable manner.

Each of the circuit leads 124 may consist essentially of an electrical wire (sheathed or unsheathed) that is formed, in whole or in part, from an electrically conductive material (e.g., copper). In this instance, the lead 124 may extend continuously from one end of the cell case 112, across the panel 120, to the other end of the case 112. To facilitate packaging and electrically interconnecting the battery cells 102, it may be most efficient to route the lead 124 along a topmost or bottom-most surface of the battery container and pressure burst cover. For any of the illustrated applications, the circuit lead 124 may be immovably attached onto cap and battery (e.g., via adhesives, interference-fitting channels, clamps. fasteners, etc.) or integrated into cap and battery (e.g., (e.g., via two-shot over molding, threading, etc.). In either case, a lefthand (first) side of the pressure burst plate or panel 118, 120 is fixedly mounted by a distinct (first) segment of the circuit lead 124 to a lefthand (first) section of the header 114, whereas a righthand (second) side of the panel 120 is fixedly mounted by a different (second) segment of the lead 124 to a righthand (second) section of the header 114. Optional system architectures may employ a pin-and-sleeve connector, a pin-and-socket connector, a single-pole connector, a crimp connector, a terminal block connector, etc. (collectively represented at 128 in FIG. 2) that holds the pressure burst cap in the closed position and opens at a preset rupture force.

During normal system operation, an interlock circuit lead retains its corresponding pressure burst cap in a closed position; when subjected to a tensile/torsional force that meets or exceeds a preset rupture force, the lead wholly or partially fails to produce an interlock circuit signal that is indicative of a thermal event and contemporaneously release the burst cap. In FIG. 3B, for example, the lithium-class prismatic battery cells 102 has entered thermal runaway and the electrochemical jellyroll stack 116 inside the cell case 112 has started to emit high-temperature, high-pressure gases. This gas generates an expansive force (arrow FTR) on an inner face of the pressure burst panel 120 that pushes the panel 120 outwards (e.g., vertically upwards in FIG. 3A). By pushing the panel 120 open, the expanding gas concurrently applies a tensile force on the interlock circuit lead 124. When the tensile force exceeds a preset threshold rupture force, the circuit lead 124 deforms, cracks, or ruptures such that the pressure burst panel 120 moves from the closed position (FIG. 3A) to the open position (FIG. 3B) and, as shown, physically detaches from the cell case header 114. The material, gauge, and/or cross-sectional geometry of the lead 124 may be engineered such that the lead's yield strength corresponds to a rupture force that is predicted to occur at the onset of TR.

When the interlock circuit lead 124 fails due to the TR gas release, an open circuit signal is created within the electrical interlock circuit 122 and detected by the EBCM 130. In particular, the electrical interlock circuit 122 may maintain a continuous or continual electrical voltage across all of the circuit lead 124 during normal operation of the battery system. The EBCM 130 systematically monitors the interlock circuit 122 for this voltage signal to ensure none of the pressure burst caps have opened. When a lead 124 fails, an open circuit is created by the discontinuation of the electrical voltage across the electrical interlock circuit; the EBCM 130 detects and flags this open circuit as a thermal runaway event. Upon detection of TR, mitigating measures may be taken to stop or diminish the effects of the thermal event.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A battery assembly, comprising:
an electrochemical battery cell;
a battery container housing therein the battery cell, the battery container including a container wall with a fluid port configured to evacuate therethrough cell-generated gas;
a pressure burst cap movably attached to the battery container to selectively transition between a closed position, whereat the pressure burst cap covers the fluid port, and an open position, whereat the pressure burst cap at least partially uncovers the fluid port; and
an electrical interlock circuit configured to connect to a controller and including a circuit lead attached to the pressure burst cap and the battery container, the circuit lead holding the pressure burst cap in the closed position and configured to fail at a preset rupture force thereby creating an open circuit signal within the electrical interlock circuit indicative of a thermal event.

2. The battery assembly of claim 1, wherein the circuit lead movably mounts the pressure burst cap to the battery container such that the pressure burst cap selectively moves from the closed position to the open position upon failure of the circuit lead.

3. The battery assembly of claim 2, wherein the circuit lead consists essentially of an electrical wire formed with an electrically conductive material and rigidly attached to both the pressure burst cap and the battery container.

4. The battery assembly of claim 1, wherein the circuit lead ruptures at the preset rupture force such that the pressure burst cap physically detaches from the battery container.

5. The battery assembly of claim 1, wherein the circuit lead includes an electrical wire fixedly mounted to and extending across exterior surfaces of both of the pressure burst cap and the battery container.

6. The battery assembly of claim 1, wherein a first side of the pressure burst cap is mounted by a first segment of the circuit lead to a first section of the battery container, and a second side of the pressure burst cap is mounted by a second segment of the circuit lead to a second section of the battery container.

7. The battery assembly of claim 1, wherein the pressure burst cap, when in the closed position, extends across the fluid port and sits substantially flush against the container wall.

8. The battery assembly of claim 1, wherein the circuit lead maintains an electrical voltage across the electrical interlock circuit detectable by the controller, and wherein the open circuit signal is created by discontinuation of the electrical voltage across the electrical interlock circuit when the circuit lead fails at the preset rupture force.

9. The battery assembly of claim 1, wherein the circuit lead includes a pin-and-sleeve connector, a pin-and-socket connector, and/or a single-pole connector holding the pressure burst cap in the closed position and configured to fail by opening at the preset rupture force.

10. The battery assembly of claim 1, wherein the pressure burst cap is fabricated from a polymeric material as a single-piece structure.

11. The battery assembly of claim 1, wherein the pressure burst cap, when in the closed position, fluidly seals the fluid port and, when in the open position, fluidly unseals the fluid port.

12. The battery assembly of claim 1, wherein the battery container includes a battery module housing, and wherein the electrochemical battery cell includes a cluster of lithium-class battery cells.

13. The battery assembly of claim 1, wherein the battery container includes a battery cell case, and wherein the electrochemical battery cell includes multiple working electrodes, a separator, an insulator, and an electrolyte all contained inside the battery cell case.

14. A motor vehicle, comprising:
a vehicle body;
a plurality of road wheels attached to the vehicle body;
a traction motor attached to the vehicle body and operable to drive one or more of the road wheels to thereby propel the motor vehicle; and
a traction battery pack attached to the vehicle body and electrically connected to the traction motor, the traction battery pack including an electrical interlock circuit electrically connected to a vehicle controller and including a network of circuit leads, the traction battery pack containing multiple lithium-class battery cells, each of the lithium-class battery cells including:
a battery stack with multiple working electrodes, a separator, an insulator, and an electrolyte;
a cell case containing therein the battery stack, the cell case including a cell case wall defining a fluid port configured to evacuate therethrough cell gases generated by the battery stack;
a pressure burst cap movably attached to the cell case to transition from a closed position, whereat the pressure burst cap covers the fluid port, to an open position, whereat the pressure burst cap uncovers the fluid port; and
a circuit lead of the network of circuit leads movably mounting the pressure burst cap to the cell case, the circuit lead holding the pressure burst cap in the closed position and configured to fail at a preset rupture force thereby enabling the pressure burst cap to transition to the open position and creating an open circuit signal within the electrical interlock circuit indicative of a thermal runaway event.

15. A method of constructing a battery assembly, the method comprising:
receiving an electrochemical battery cell and a battery container;
placing the battery cell inside the battery container, the battery container including a container wall with a fluid port configured to evacuate therethrough cell-generated gas;
placing a pressure burst cap over the fluid port such that the pressure burst cap selectively transitions from a closed position, whereat the pressure burst cap covers the fluid port, to an open position, whereat the pressure burst cap at least partially uncovers the fluid port;
receiving an electrical interlock circuit configured to connect to a controller and including a circuit lead; and
attaching the circuit lead to the pressure burst cap and the battery container, the circuit lead holding the pressure burst cap in the closed position and configured to fail at a preset rupture force thereby creating an open circuit signal within the electrical interlock circuit indicative of a thermal event.

16. The method of claim 15, wherein attaching the circuit lead to the pressure burst cap movably mounts the pressure burst cap to the battery container such that the pressure burst cap selectively moves from the closed position to the open position upon failure of the circuit lead.

17. The method of claim 16, wherein the circuit lead consists essentially of an electrical wire formed with an electrically conductive material and rigidly attached to both the pressure burst cap and the battery container.

18. The method of claim 15, wherein the circuit lead ruptures at the preset rupture force such that the pressure burst cap physically detaches from the battery container.

19. The method of claim 15, wherein the pressure burst cap, when in the closed position, extends across the fluid port and sits substantially flush against the container wall.

20. The method of claim 15, wherein the pressure burst cap is fabricated from a polymeric material as a single-piece structure.
